(19) United States
(12) Patent Application Publication
(10) Pub. No.: US 2006/0153382 A1
(43) Pub. Date: Jul. 13, 2006

(54) Extremely fast data encryption, decryption and secure hash scheme

(75) Inventor: Anthony Mai, San Marcos, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Computer Entertainment America Inc., Foster City, CA (US)

(21) Appl. No.: 11/035,285

(22) Filed: Jan. 12, 2005

(51) Int. Cl. H04K 1/00

(52) U.S. Cl. 380/251

(57) ABSTRACT

An extremely fast data encryption, decryption and secure hash scheme encrypts or hashes data of any size, and can be implemented in a variety of software or hardware based data processing devices. A key and data are prepared for processing by separating them into a series of four byte integers, pad with zero bytes as necessary. A bit manipulation unit having four registers A, B, C and D that are each thirty-two bits long is initialized by loading the key into the registers. A series of operations are performed on the registers to manipulate bits in the registers. An exclusive OR (XOR) operation is then performed on contents of register D and a portion of the data to be processed.

### BACKGROUND OF THE INVENTION

1. Field of the Invention

The present invention relates generally to schemes for providing online security, and more specifically to an extremely fast encryption, decryption and secure hash procedure.

2. Discussion of the Related Art

Computer entertainment game systems, such as the Sony PlayStation® and PlayStation® 2, have become some of the most successful consumer electronics products to hit store shelves in recent years. And recently, the advent of online gaming has enabled people to play games with opponents around the world via large networks, such as the Internet. Such online gaming is rapidly becoming very popular. Unfortunately, along with such success and flexibility comes the increased potential for abuse by those who seek to improperly tamper with online transmissions and transactions.

For example, in the online or network enabled game system scenario players may attempt to cheat at a game by altering the data that is sent across the network (e.g. the Internet). Or, a hacker or prankster may perform a so-called “man in the middle” attack whereby the hacker seeks to interfere with or to intercept a message that is being communicated over the Internet between two game systems. The hacker, who may be motivated by a desire to cheat or to disrupt play of the game by the two legitimate users, may seek to alter the data being communicated. Such abuse can disadvantageously cause confusion and wreak havoc among innocent users, which can ultimately lead to an unjustified distrust by the public of the systems and games themselves.

It is with respect to these and other background information factors that the present invention has evolved.

### SUMMARY OF THE INVENTION

The present invention advantageously addresses the needs above as well as other needs by providing a method for use in processing data. The method comprises the steps of: loading a key into a plurality of registers; performing a series of operations on the registers to manipulate bits in the registers; and performing an exclusive OR (XOR) operation on contents of one of the registers and a portion of the data.

Another embodiment of the present invention provides a system for use in processing data. The system comprises a plurality of registers and a processing unit. The processing unit is configured to load a key into the plurality of registers; perform a series of operations on the registers to manipulate bits in the registers; and perform an exclusive OR (XOR) operation on contents of one of the registers and a portion of the data.

And another embodiment of the present invention provides a computer program product comprising a medium for embodying a computer program for input to a computer and a computer program embodied in the medium. The computer program embodied in the medium is for causing the computer to perform steps of: loading a key into a plurality of registers; performing a series of operations on the registers to manipulate bits in the registers; and performing an exclusive OR (XOR) operation on contents of one of the registers and a portion of data.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a schematic diagram illustrating a bit manipulation unit that operates in accordance with an embodiment of the present invention;

FIG. 2 is a flow diagram illustrating a method of operating the bit manipulation unit shown in FIG. 1 in accordance with an embodiment of the present invention;

FIG. 3 is a schematic diagram illustrating use of the method shown in FIG. 2 for the task of encrypting data in accordance with an embodiment of the present invention;

FIG. 4 is a flow diagram illustrating a procedure that may be used in implementing the encryption task illustrated in FIG. 3 in accordance with an embodiment of the present invention;

FIG. 5 is a schematic diagram illustrating use of the method shown in FIG. 2 for the task of decrypting data in accordance with an embodiment of the present invention;

FIG. 6 is a flow diagram illustrating a procedure that may be used in implementing the decryption task illustrated in FIG. 5 in accordance with an embodiment of the present invention; and

FIG. 7 is a schematic diagram illustrating use of the method shown in FIG. 2 for the task of securely obtaining a one way hash value of data of any length in accordance with an embodiment of the present invention.

Corresponding reference characters indicate corresponding components throughout the several views of the drawings.

### DETAILED DESCRIPTION

One way to reduce the likelihood of the types of abuse described above with respect to online or network enabled gaming is to encrypt the communications sent over the Internet between the game systems. Such encryption needs to be very fast because the games are played in real time. Unfortunately, however, conventional encryption methods tend to not be fast enough for optimal effectiveness in the online gaming scenario. Examples of some conventional encryption methods are RC4 Encryption, the Software Encryption Algorithm (SEAL), and the Data Encryption Standard (DES).

Most conventional encryption methods use a substitution box (or S-box), which is a basic component of symmetric key algorithms. In block ciphers, they are typically used to obscure the relationship between the plaintext and the ciphertext, which is a use based on Shannon's property of the sequential application of confusion and diffusion.

It has been found by the inventor hereof that use of an S-box utilizes a certain amount of central processing unit (CPU) time during the encryption process. Specifically, S-boxes are typically composed of an array of bytes or four-byte-integers. The amount of data used in an S-box is typically too large to fit in a CPU. For example, RC4 Encryption uses an S-box of 256 bytes, which is one of the smallest. That amount of memory cannot all be accommodated by CPU registers, which means it has to reside in the memory. So any access to S-box data involves memory access and cost extra CPU time, versus the case where only CPU registers need to be accessed.

Furthermore, S-boxes need to be initialized by scrambling the data in a certain way. That initialization is time costly because all of the bytes in the S-box have to be scrambled, even if only a few bytes are to be encrypted. Therefore, the use of an S-box is not suitable for applications where cipher initialization needs to happen often.

Embodiments of the present invention herein described provide an encryption/decryption and secure hash scheme that does not use an S-box. The encryption/decryption and secure hash scheme provided by embodiments of the present invention is extremely fast, in part because the S-box has been eliminated, which frees-up CPU time.

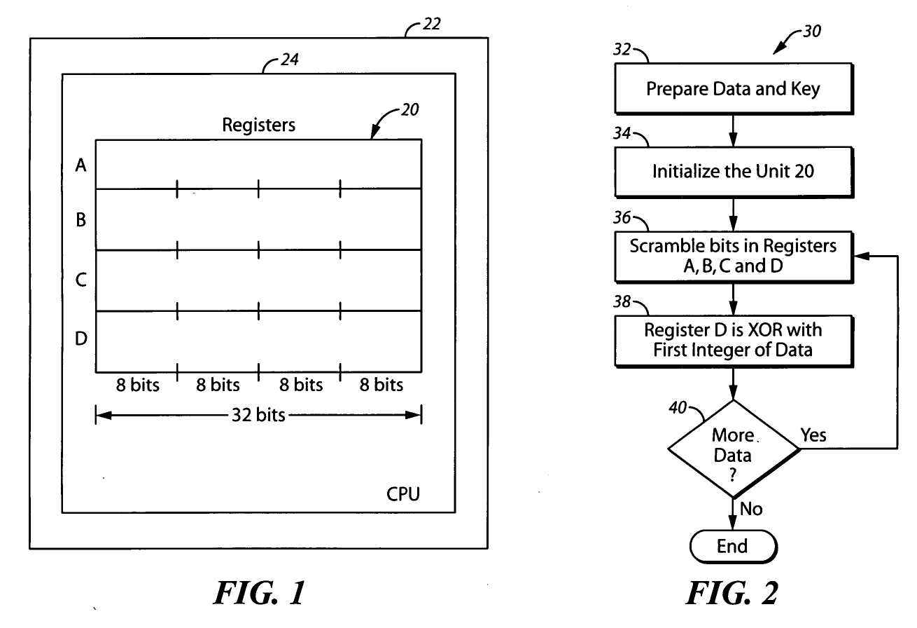

Referring to FIG. 1, there is illustrated a bit manipulation unit 20 that is configured and that operates in accordance with an embodiment of the present invention. The unit 20 and the methods described herein are capable of providing an extremely fast data encryption/decryption and secure hash procedure on any hardware or software based digital data processing device without the need for an S-box. As such, the unit 20 may also be referred to as an encryption/decryption or hashing unit 20.

The unit 20 and the methods described herein enable any computing device to carry out extremely fast encryption/decryption/hashing operations that are very secure. Both the encryption and initialization of the processing unit are very fast. For example, on a typical 1700 MHz personal computer (PC), the realistic data throughput in a typical assembly code implementation can be about 265-270 mega bytes per second. Actually measured peak data throughput can be one byte per three (3) clock cycles. Faster speeds may be possible depending upon the configuration of the implementing software code. This speed performance is much faster than some of the most publicly known fast symmetric ciphers, including RC4 and SEAL. And in accordance with other embodiments of the present invention, several of the units 20 may be cascaded together to achieve higher security.

The illustrated embodiment of the unit 20 uses only sixteen bytes of data storage. The simplicity makes it suitable for implementation on a wide variety of software and hardware applications, which are indicated by box 22. For example, box 22 may comprise a software application or a game system or console, such as for example past, present or future versions of the popular Sony PlayStation®, or any other type of computer system, processing system, game system, or the like. By way of example, the unit 20 may be implemented by using registers in a Central Processing Unit (CPU) 24. In the scenario where box 22 comprises software, the computer program may be stored or embodied in a computer readable medium, such as for example any type of digital memory.

The unit 20 and the methods described herein provide for fast processing speed on X86 CPU based systems, which are commonly used as data servers. In the illustrated embodiment of the unit 20, four state values are chosen because of the limited number of registers. This provides adequate security (128 bits encryption strength) while allowing the core operations to be carried out on registers only, without memory access. Because there is no memory access, the procedures are very fast.

The illustrated embodiment of the unit 20 includes four registers, each thirty-two bits long. These four registers, referred to as registers A, B, C and D, store the current state of the processing unit. As such, the unit 20 encrypts or hashes data in units of four bytes (thirty-two bits), and can be implemented in a variety of software or hardware based data processing devices.

In the illustrated embodiment, the only time memory needs to be accessed (in order to access data) during the encryption loop is when data to be encrypted is fetched from the memory and when the encrypted data is put back in the memory. The registers A, B, C and D themselves may sit in the CPU, not in the memory, so the scrambling process of A, B, C and D involves no memory access. It should be understood that while the registers A, B, C and D themselves may be in the CPU, the registers may also be located somewhere else outside of the CPU.

Referring to FIG. 2, there is illustrated a method 30 of operating the unit 20 in accordance with an embodiment of the present invention. In step 32 the data and the key are prepared for processing, in step 34 the unit 20 is initialized, in step 36 a series of operations are performed on registers A, B, C and D in the unit 20 to manipulate or scramble the bits, and in step 38 the contents of register D is exclusive ORed with an equal length of the data. As illustrated by step 40, steps 36 and 38 are repeated until all of the data has been processed.

The method 30 can be used to perform several tasks. For example, the method 30 can be used to encrypt data by scrambling the bits in certain ways, to decrypt data by descrambling the bits in certain ways, to securely obtain a sixteen byte (128 bits) one way hash value of data of any length, to securely obtain a challenged hash value of data of any length, and to obtain a four byte (thirty-two bits) value for verifying integrity of the data. In certain embodiments of the present invention, each of these tasks may center on the manner in which the four state integers of thirty-two bits each in the unit 20 are manipulated.

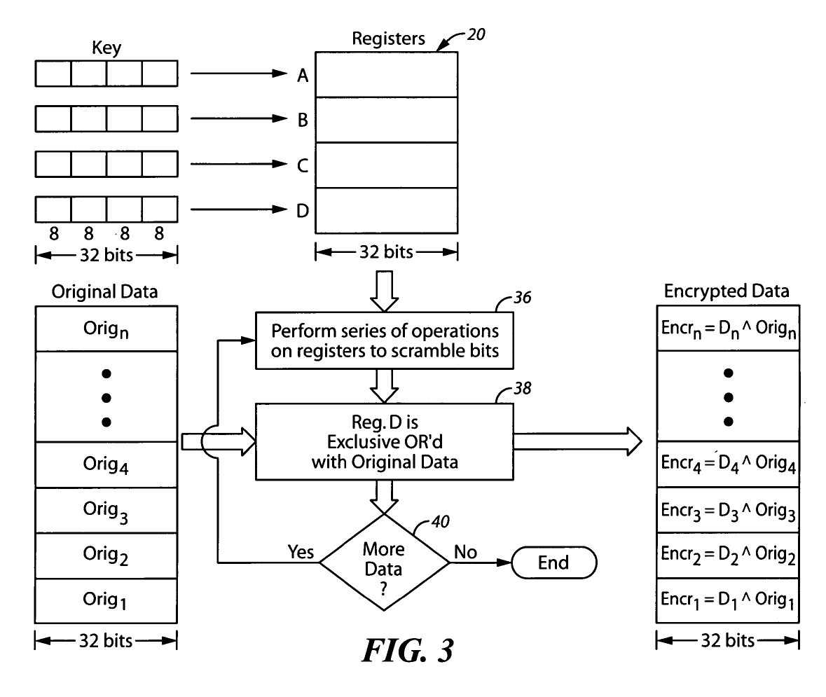

The method 30 will be further described in conjunction with FIG. 3 for the task of encrypting data. Specifically, for step 32 in which the data and the key are prepared for processing, all of the original data and encryption key are separated into a series of four byte (thirty-two bit) integers. If the total length is not a multiple of four bytes, zero bytes are padded until the total length is a multiple of four bytes. Each four bytes is considered one integer. The four byte integers of the original data are illustrated as Orig₁, Orig₂, Orig₃, . . . Origₙ.

The bytes within each integer are assumed to be in little endian, i.e., the least significant byte is the first byte and the most significant byte is the last byte within the four byte group. If the system of implementation is big endian, then the bytes within each four byte group are swapped to make it little endian before processing, and then swapped again after processing to make it big endian.

For step 34 in which the unit 20 is initialized, again, the present description describes initializing the processing unit for the task of encryption using a key, although as will be discussed below the process is the same for the task of decryption. Specifically, for the encryption/decryption procedure a secret key is used to first initialize the unit. The key is 128 bits long, or sixteen bytes, or four integers of four bytes each. If the key is longer than sixteen bytes, then it is truncated to use the first sixteen bytes only. If the key is shorter than sixteen bytes, then zero bytes are padded until the length is sixteen bytes. The four integer values of the key are then copied into registers A, B, C and D, respectively, of the unit 20 as illustrated.

In step 36 a series of operations are performed on registers A, B, C and D in the unit 20 to manipulate or scramble the bits. A specific set of operations in accordance with an embodiment of the present invention will be described below.

After the bits in registers A, B, C and D have been scrambled, in step 38 the contents of register D is exclusive ORed with the first four byte integer of the original data, namely Orig₁. This operation creates the first four byte integer of the encrypted data, which is Encr₁=D₁ ˆ Orig₁.

In order to process the next four byte integer of the original data steps 36 and 38 are repeated. Namely, the same series of operations are again performed on registers A, B, C and D to scramble the bits. Then, the contents of register D is exclusive ORed with the second four byte integer of the original data, namely Orig₂. This operation creates the second four byte integer of the encrypted data, which is Encr₂=D₂ ˆ Orig₂. Steps 36 and 38 are repeated until all of the original data has been processed as indicated by step 40.

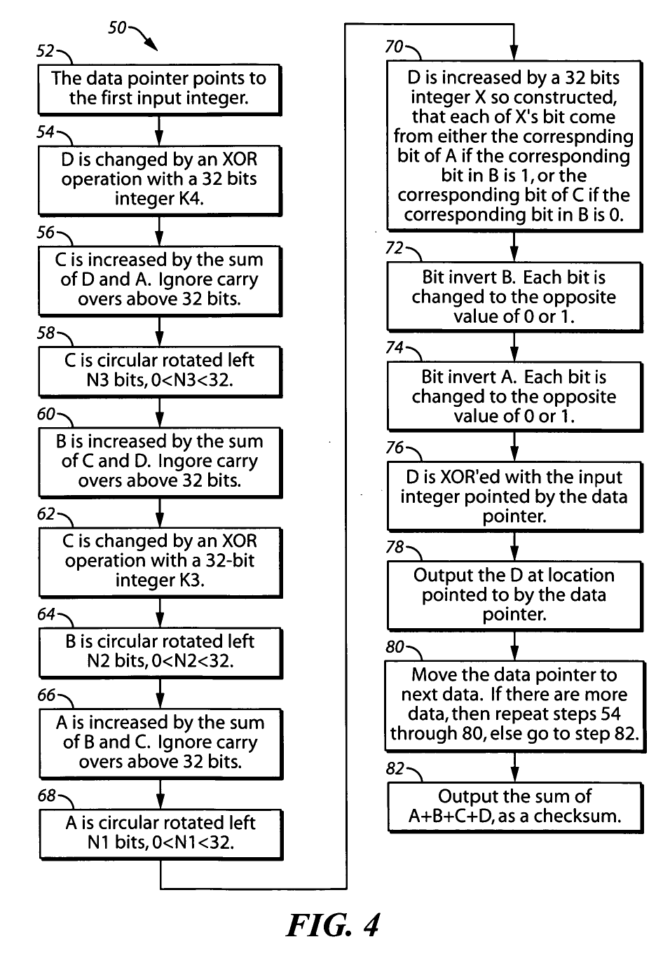

Referring to FIG. 4, there is illustrated an encryption method 50 of scrambling the bits in registers A, B, C and D in accordance with an embodiment of the present invention. The method 50 performs all of steps 36, 38 and 40 described above for the task of encryption.

In the method 50 (as well as the method 90 discussed below), the processing steps have been selected so that entropy can quickly dissipate into the four state registers A, B, C and D. A mixture of ADD, XOR and Bit-Rotate operations have been selected so that a change of just one bit in any of the four integers at the beginning could affect almost 90% of all bits of all four integers, in a random fashion, after just one iteration. Step 70 (as well as step 110 discussed below), although a little bit expensive in CPU time, brings in more none-linearity and makes it more secure. Operations like OR and AND are rarely used because they have a tendency of making bit 1 or 0 more likely, and hence more predictable. Operation NOT neither increases the unpredictability of bit nor spreads the bits, so it is sparingly used. Operation SUB has the same effect as ADD so it is not used either. Multiply and divisions are not used because they take too much CPU time.

In the addition and subtraction operations involved with the four integers, such addition and subtraction may result in carry over, or borrowing from above thirty-two bits. In all such cases in the illustrated embodiment of the method 50 the carry over or borrowing is ignored and only the lowest thirty-two bits of the results are preserved.

Overall, in the illustrated embodiment of the method 50 (as well as the method 90 discussed below), each step is designed and evaluated so that only necessary operations that can maximize the scrambling of bits at minimum CPU clock cycle cost are used.

The method 50 begins with step 52 in which the data pointer points to the first input integer of the original data, i.e., Orig₁.

Next, in step 54, register D is changed by an XOR operation with a thirty-two bit integer K4.

In step 56 register C is increased by the sum of registers D and A, with carry overs above thirty-two bits being ignored.

In step 58 register C is circular rotated left N3 bits, where 0<N3<32.

In step 60 register B is increased by the sum of registers C and D, with carry overs above thirty-two bits being ignored.

In step 62 register C is changed by an XOR operation with a thirty-two bit integer K3.

In step 64 register B is circular rotated left N2 bits, where 0<N2<32.

In step 66 register A is increased by the sum of registers B and C, ignoring carry overs above thirty-two bits.

In step 68 register A is circular rotated left N1 bits, where 0<N1<32.

In step 70 register D is increased by a thirty-two bit integer X so constructed, that each of X's bits come from either the corresponding bit of register A if the corresponding bit in register B is 1, or the corresponding bit of register C if the corresponding bit in register B is 0.

In step 72 a bit invert operation is performed on register B, namely, each bit is changed to the opposite value of 0 or 1.

In step 74 a bit invert operation is performed on register A, namely each bit is changed to the opposite value of 0 or 1.

In step 76 register D is XOR'ed with the input integer pointed to by the data pointer.

In step 78 the contents of register D are output at the location pointed to by the data pointer.

In step 80 the data pointer is moved to the next data integer. If there are more data integers to be processed, then steps 54 through 80 are repeated.

If all of the data has been processed, then in step 82 the sum of registers A+B+C+D, ignoring any carry overs and rounded to the lowest thirty-two bits, is output as a checksum. This checksum is a four byte (thirty-two bits) value that can be used for verifying the integrity of the data.

By way of example, the method 50 may use the constant values of: N1=17; N2=11; N3=7; K3=0x75970A4D; K4=0x5B3AA654. These values are selected because N1, N2 and N3 are co-prime to thirty-two bits, and they allow bits to rotate and spread to other bit positions fast. The values K3 and K4 are chosen to contain random and about equal distribution of 1s and 0s in the bits. It should be well understood, however, that other constant values may be used.

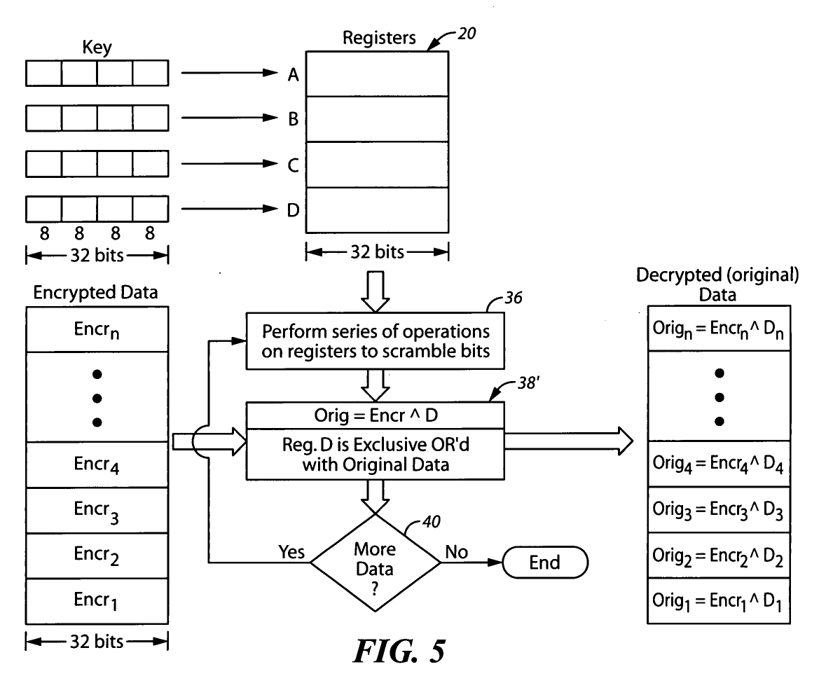

The method 30 (FIG. 2) will now be further described in conjunction with FIG. 5 for the task of decrypting data. An example of where the task of decryption would be performed is in the scenario of an on-line game where the encrypted data is sent across the Internet to another player. In this scenario the other player receives the encrypted data and uses the secret key that he or she already possesses to decrypt the data according to the following process.

Specifically, in step 32 the key and the encrypted data are prepared in the same manner as described above for the task of encrypting data. Similarly, in step 34 the unit 20 is initialized in the same manner as described above for the task of encrypting data. Namely, a secret key that is 128 bits long, or sixteen bytes, or four integers of four bytes each, is copied into registers A, B, C and D, respectively. If the key is longer than sixteen bytes, then it is truncated to use the first sixteen bytes only. If the key is shorter than sixteen bytes, then zero bytes are padded until the length is sixteen bytes.

In step 36 a series of operations are performed on registers A, B, C and D in the unit 20 to manipulate or scramble the bits. The series of operations are the same as those used for the encryption task. A specific set of operations in accordance with an embodiment of the present invention will be described below.

For the task of decryption, step 38 includes an extra step, and so it is designated in FIG. 5 as step 38′. Specifically, in step 38′the first four byte integer of the encrypted data, namely Encr₁, is exclusive ORed with the contents of register D. This operation creates the first four byte integer of the decrypted data, which is the original data, which is Orig₁=Encr₁ ˆ D₁. Then, as in step 38 described above, the contents of register D is exclusive ORed with the resulting integer, which is the original data, in this case Orig₁.

In order to process the next four byte integer of the encrypted data steps 36 and 38′ are repeated. Namely, the same series of operations are again performed on registers A, B, C and D to scramble the bits. Then, the second four byte integer of the encrypted data, namely Encr₂, is exclusive ORed with the contents of register D. This operation creates the second four byte integer of the decrypted data, which is Orig₂=Encr₂ ˆ D₂. Steps 36 and 38′ are repeated until all of the encrypted data has been processed as indicated by step 40.

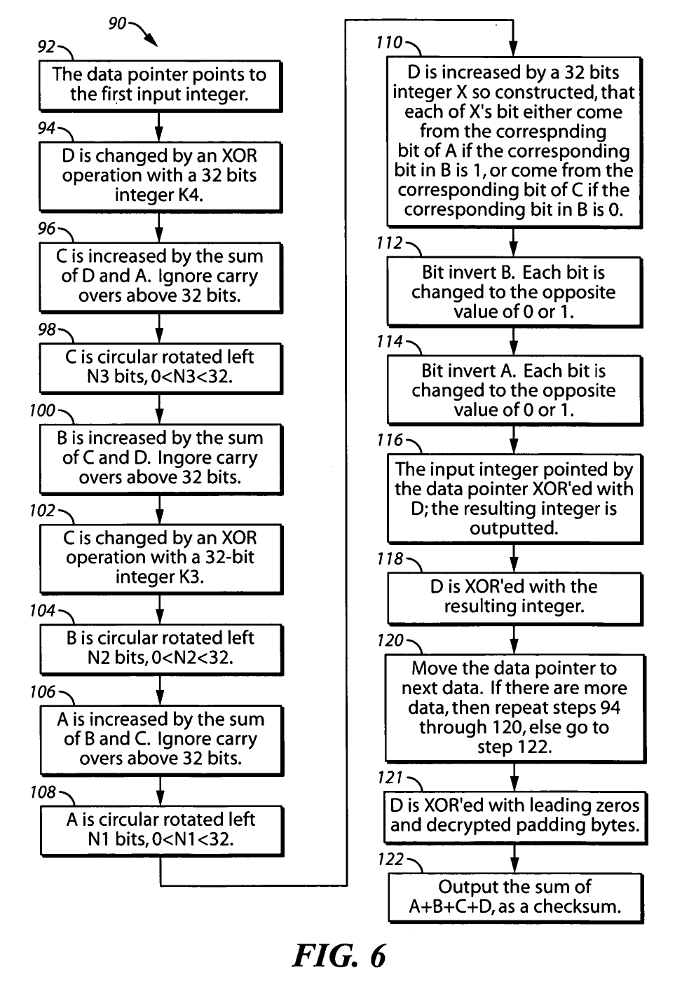

Referring to FIG. 6, there is illustrated a decryption method 90 of scrambling the bits in registers A, B, C and D in accordance with an embodiment of the present invention. The method 90 performs all of steps 36, 38′ and 40 described above for the task of decryption. The decryption procedure 90 is identical to the encryption procedure 50 except for steps 76 and 78, and the decryption procedure 90 also includes one extra step.

The method 90 begins with step 92 in which the data pointer points to the first input integer of the encrypted data, i.e., Encr₁.

Next, in step 94, register D is changed by an XOR operation with a thirty-two bit integer K4.

In step 96 register C is increased by the sum of registers D and A, with carry overs above thirty-two bits being ignored.

In step 98 register C is circular rotated left N3 bits, where 0<N3<32.

In step 100 register B is increased by the sum of registers C and D, with carry overs above thirty-two bits being ignored.

In step 102 register C is changed by an XOR operation with a thirty-two bit integer K3.

In step 104 register B is circular rotated left N2 bits, where 0<N2<32.

In step 106 register A is increased by the sum of registers B and C, ignoring carry overs above thirty-two bits.

In step 108 register A is circular rotated left N1 bits, where 0<N1<32.

In step 110 register D is increased by a thirty-two bit integer X so constructed, that each of X's bits either come from the corresponding bit of register A if the corresponding bit in register B is 1, or come from the corresponding bit of register C if the corresponding bit in register B is 0.

In step 112 a bit invert operation is performed on register B, namely, each bit is changed to the opposite value of 0 or 1.

In step 114 a bit invert operation is performed on register A, namely each bit is changed to the opposite value of 0 or 1.

In step 116 the input integer pointed to by the data pointer is XOR'ed with register D. The resulting integer is then outputted.

In step 118 register D is XOR'ed with the resulting integer.

In step 120 the data pointer is moved to the next data integer. If there are more data integers to be processed, then steps 94 through 120 are repeated.

With respect to step 121, it was mentioned above that in preparing the data for processing before encryption, if the amount of data is not an exact multiple of four bytes, it is padded with zero bytes to make it a multiple of four bytes. Specifically, the zero padding makes the total data length, which was less than a four byte multiple, a size of exactly a four byte multiple so it can be encrypted by the main loop, which in the illustrated embodiment always takes four bytes at a time.

The padded bytes are zero before encryption, but are scrambled and become non-zero after encryption. This part of the data is not transferred through the network because they are beyond the original data length. So the receiving end will not be able to correctly decrypt the padded bytes. This is perfectly acceptable for obtaining the correct original data, up to the original data length. But the cipher state itself will no longer be the same on both the sending side and the receiving side, and if subsequent encryption is performed from that cipher state, the data will not be decrypted correctly.

As an optional step, step 121 may be used on the decryption side to solve this problem. In general, the decryption of the final few padding bytes should result in getting back zero bytes for those padding bytes. Because it is known that the decryption will result in getting back zero bytes for the padding bytes, the scrambled padding bytes can be calculated even though the padding bytes were never received.

The following example illustrates how step 121 works. Namely, assume that there are five bytes of data to be encrypted and transmitted, which are: 1234 5XYZ WUVT. With the length of five, the XYZ WUVT, which follows the legitimate data, should not be modified at the end. On the sending side, the data is padded to make it a multiple of four bytes. To save the extra CPU time needed to figure out how many bytes are to be padded, four bytes are backed up right after the last data byte, setting those four bytes to zeros, and encrypting the data until there is only four bytes or less left. And when the encryption is all done, those four bytes are restored back to their original values. This way, only the original data length is modified and anything beyond that is not touched.

Thus, for this example, padding on the sending side results in: 1234 5000 0UVT. That is, four zeros are inserted right after the five bytes of data, making it a total of nine bytes. The bytes XYZW are stored away some where else. Then, the nine bytes are encrypted up until four or less bytes are left, which means eight bytes get encrypted. This results in abcd efgh 0UVT.

Next, the original four bytes are recovered with the original data XYZW, which results in: abcd eXYZ WUVT. Since the original data is only five bytes, the first five bytes are transmitted, namely: abcd e. Thus, the fgh, though part of encrypted data, does not get sent.

On the receiving end, the system does not know what the three encrypted padding bytes were, so zeros are filled in, resulting in: abcd e000. Again, the correct data should be: abcd efgh. After decryption, the system obtains: 1234 5f′g′h′. The last three bytes are wrong because it is known that on the sending end the system started with 000, not fgh.

In other words, it is known that the last three bytes are supposed to be 000. To get the result, another XOR on the final value of D is performed to correct for it: D=D ˆ 0f′g′h′. After this last operation, the D value on the decrypting cipher will be the same as on the encrypting end. This final step, i.e. D=D ˆ (leading zeros+decrypted padding bytes), is performed in step 121 in FIG. 6.

If all of the data has been processed, then in step 122 the sum of registers A+B+C+D, ignoring any carry overs and rounded to the lowest thirty-two bits, is output as a checksum. This checksum should match the checksum computed during the encryption task.

The decryption procedure 90 will use the same constant values as the encryption procedure 50, such as the example constant values provided above. Again, it should be well understood that other constant values may be used.

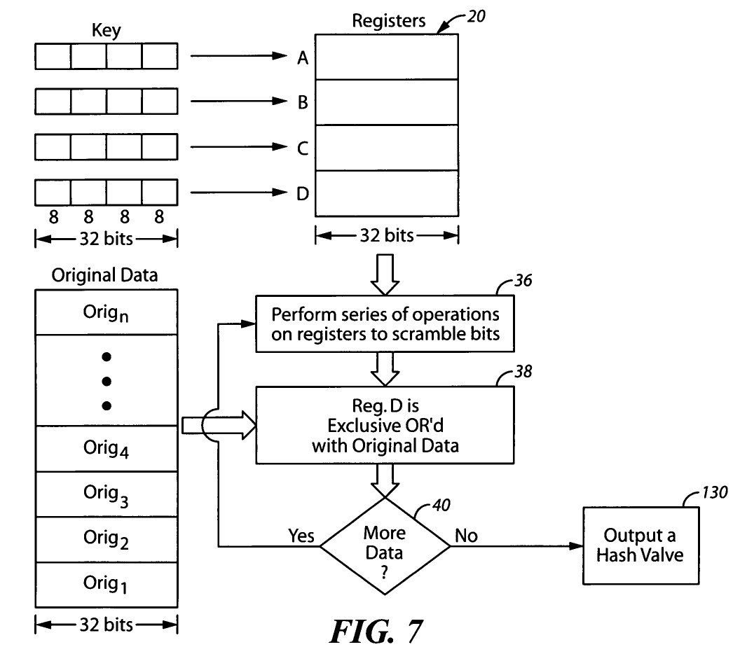

The method 30 (FIG. 2) will now be further described in conjunction with FIG. 7 for the task of obtaining a hash value. Hashing is the transformation of a string of characters into a usually shorter fixed-length value or key that represents the original string. It is often used for providing digital signatures and authenticating users in a networked environment.

Various embodiments of the present invention are capable of performing three different hash processes. In certain embodiments the hash processes are all identical in the main loop that processes the data. The differences are in how the processing unit 20 is initialized, or in other words, the difference lies in the key used to initialize the processing unit 20 before it starts to hash the first four bytes of the data.

Specifically, for a secured hash, i.e., the un-salted and un-challenged hash, the key used for initialization is a pre-selected and fixed sixteen bytes value. In the simplest implementation this is simply sixteen bytes of zeros. Embodiments of the present invention are capable of securely obtaining a one way hash value of data of any length.

For a salted hash, the key used is a four bytes integer. As described above, the four bytes will be extended to a full sixteen bytes by adding zero bytes, and then the full sixteen bytes is used to initialize the processing unit 20 before hashing.

For a challenged hash, the key is a sixteen bytes random value, provided by the other side (the challenging side). The same initialization is done using this sixteen bytes. It is referred to as a challenged hash because the other side randomly selects sixteen bytes and challenges the first side to generate the correct hash result. If the data is correct the correct result will always be generated, no matter what random sixteen bytes is used.

In some embodiments of the present invention the hash operation, as well as the checksum operation, are almost identical to encryption, except for the unit 20 is initialized in slightly different ways. For example, the unit 20 may be initialized by first setting all four integers to zero, then encrypting (scrambling) itself using the encryption function described above. The rest of the process is almost identical to the encryption function described above, except that at each iteration the encrypted data is simply thrown away and is not put back into the data buffer. The final output is calculated from the final state of the ABCD integer. In the case of the hash procedure, the final output may be four integers, which are calculated by BˆCˆD, CˆDˆA, DˆAˆB, AˆBˆC, respectively. In the case of the checksum procedure, the final output may be simply the sum of A+B+C+D, rounded to thirty-two bits.

Turning to the embodiment illustrated in FIGS. 2 and 7, in step 32 the key and the data to be hashed are prepared in the same manner as described above for the task of encrypting data. For step 34, initializing of the unit 20 for secured hashing operation is basically the same as described above, but instead of a secret key, a fixed and known sixteen byte key is used to initialize the unit 20 in the way described above. Steps 36, 38 and 40 are performed in the same manner as with the encryption task described above, except that the data is not output as described for the encryption task. Instead, a certain number of integers, which is the hash value, are output at step 130 after all of the data has been processed.

An example of securely obtaining a sixteen byte (128 bits) one way hash value of data of any length in accordance with an embodiment of the present invention is as follows. Specifically, steps 36, 38 and 40 of the hashing procedure are implemented to be identical to the encryption procedure 50 (FIG. 4), except that the data is not output as described in step 78. Furthermore, in the final output, instead of outputting the sum of registers A+B+C+D in step 82, four integers are output, which are respectively (BˆCˆD), (CˆDˆA), (DˆAˆB), (AˆBˆC). These four integers make up the sixteen byte one way hash value. This hashing procedure can use the same constant values provided above, or other constant values may be used.

The method 30 (FIG. 2) can also be used for the task of securely obtaining a challenged or salted hash value of data of any length. A salted hash can be obtained by pre-pending a four bytes random value, i.e. the salt, to the data to be hashed and then computing the hash over the data and salt. Or the four bytes salt can be extended to sixteen bytes by padding zero bytes, and then the sixteen bytes value is used to initialize the processing unit, using the same initialization method described in the encryption procedures.

For a challenged hashing operation, initializing of the unit 20 is the same as for the encryption task described above, but instead of a secret key, a randomly selected sixteen bytes of data, i.e., the challenge, is used to initialize the unit in the way described above. The challenge is not a secret key in this case. The hashing procedure is then carried out as described above and illustrated in FIG. 7.

The unit 20 and the methods described above provide an extremely fast data encryption/decryption and secure hash procedure that does not require an S-box or memory accesses. The described embodiments achieve maximum data scrambling and non-linearization, at minimum CPU processing time cost, through the careful evaluation and utilization of data processing instructions available on modern CPUs. This makes the described embodiments extremely fast, very secure and their implementation very simple. Most previously available encryption algorithms considered only the mathematics but failed to take into account characteristics of CPUs.

While the embodiments described herein are useful for providing data security in the online gaming scenario, it should be well understood that the present invention may be used in many other scenarios and environments to provide data security, including any online transactions.

The following table provides a comparison of embodiments of the present invention with other known encryption methods:

| | Embodiments | | | |
|---|---|---|---|---|
| | of the | | | |
| | present | | | |
| | invention | RC4 | SEAL | DES |
| Initializing | Very Fast | Fast | Slow | Slow |
| Speed | 3 or less | 7 | 4 | 45 |
| (Clocks/Byte) | | | | |
| Data Block | 4 bytes | 1 byte | 16 | 1 byte |
| Size | | | bytes | |
| Memory Usage | 16 bytes | 258 | 3088 | 128 |
| | | bytes | bytes | bytes |
| Security | 128 bits | Varies | 192 | 56 |
| Strength | | | bits | bits |

An example of an implementation of the method 50 (FIG. 4) and the method 90 (FIG. 6) in C code in accordance with an embodiment of the present invention is as follows:

The processing unit contains 4 integers of 32 bits each:

/////////////////////////////////////////////////////////////////////
//1. For data encryption or decryption:
// 1a. Call
// rcqInit or rcqSaltyInit
// Which one to call depends on the situation in application.
// But the encrypting side and decrypting side will always
// call the same thing out of these two.
// 1b. Call
// rcqEncrypt for encryption, or
// rcqDecrypt for decryption
/////////////////////////////////////////////////////////////////////
/////////
//////// Below are the functions for encryption and decryption ////
//// There are 4 functions:
// rcqInit:
// Initialize the processing unit for both encryption and
decryption,
// using a 16 bytes key. Both encrypting and decrypting sides
will
// know the same key.
// rcqSaltyInit:
// Initialize the processing unit for both encryption and
decryption,
// using both a 16 bytes key and a random 4 bytes salt, which
changes
// from one encryption.decryption session to another. Both sides
will
// know the same key and the same salt.
// (Please note, one of either rcqInit or rcqSaltyInit will be used,
but not
// both. Which one will be used depends on the application
situation.)
//
// rcqEncrypt:
// Function to call to encrypt data. To encrypt data, you first
call
// either rcqInit( ) or rcqSaltyInit( ), and then call
rcqEncrypt( ).
//
// rcqDecrypt:
// Function to call to decrypt data. To decrypt data, you first
call
// either rcqInit( ) or rcqSaltyInit( ), and then call
rcqDecrypt( ).
void rcqInit
(

| | |
|---|---|
| const struct RC_KEY* | pKey, |
| RCQ* | pRCQ |
| ) | |

```
{
  memcpy(pRCQ, pKey, sizeof(*pRCQ));
  rcqEncrypt(pRCQ, (Byte*)pRCQ, sizeof(*pRCQ));
}
void rcqSaltyInit
(
```

| | |
|---|---|
| const struct RC_KEY* | pKey, |
| Int32 | nSalt, |
| RCQ* | pRCQ |

```
)
{
  memcpy(pRCQ, pKey, sizeof(*pRCQ));
  rcqHashUpdate(pRCQ, (Byte*)&nSalt, sizeof(nSalt));
  rcqEncrypt(pRCQ, (Byte*)pRCQ, sizeof(*pRCQ));
}
Int32 rcqEncrypt
(
  RCQ*  pRCQ,
  Byte*  pData,
  Int32  nBytes
)
{
  Int32 A = pRCQ->A;
  Int32 B = pRCQ->B;
  Int32 C = pRCQ->C;
  Int32 D = pRCQ->D;
  //Back up 4 bytes beyond our data. This will be restored later
  Int32 R = *((Int32*)&(pData[nBytes]));
  //Make those 4 bytes zero. Part of it padding bytes and encrypted
  *((Int32*)&(pData[nBytes])) = 0;
  //Loop until all input data are encrypted.
  while (nBytes > 0)
  {
    nBytes −= sizeof(Int32);
    D \hat{ }= 0x5B3AA654;
    C += D + A;
    C = (C<<7)|(C>>25);
    B += C + D;
    C \hat{ }= 0x75970A4D;
    B = (B<<11)|(B>>21);
    A += B + C;
    A = (A<<17)|(A>>15);
    D += (A&B)|(C&(˜B));
    B = ˜B;
    A = ˜A;
    D \hat{ }= *((Int32*)pData);
    *((Int32*)pData) = D;
    pData += sizeof(Int32);
  }
  pRCQ->A = A;
  pRCQ->B = B;
  pRCQ->C = C;
  pRCQ->D = D;
  //Restore the original 4 bytes backed up.
  *((Int32*)&(pData[nBytes])) = R;
  //Return the sum of A,B,C,D as a checksum.
  return (A+B+C+D);
}
Int32 rcqDecrypt
(
  RCQ*  pRCQ,
  Byte*  pData,
  Int32  nBytes
)
{
  Int32 A = pRCQ->A;
  Int32 B = pRCQ->B;
  Int32 C = pRCQ->C;
  Int32 D = pRCQ->D;
  //Back up 4 bytes beyond our data. This will be restored later
  Int32 R = *((Int32*)&(pData[nBytes]));
  //Make those 4 bytes zero. Part of it padding bytes and decrypted
  *((Int32*)&(pData[nBytes])) = 0;
  //Loop until all input data are decrypted.
  while (nBytes > 0)
  {
    nBytes −= sizeof(Int32);
    D \hat{ }= 0x5B3AA654;
    C += D + A;
    C = (C<<7)|(C>>25);
    B += C + D;
    C \hat{ }= 0x75970A4D;
    B = (B<<11)|(B>>21);
    A += B + C;
    A = (A<<17)|(A>>15);
    D += (A&B)|(C&(˜B));
    B = ˜B;
    A = ˜A;
    *((Int32*)pData) \hat{ }= D;
    D \hat{ }= *((Int32*)pData);
    pData += sizeof(Int32);
  }
  //Do we exactly decrypt all data and no padding, if nBytes==0
  if (nBytes)
  {
    //No, so do another XOR to adjust D, for the padding bytes,
which
    // should decrypt to zero bytes.
    D \hat{ }= pData[−1] & (0 − (1<<((4+nBytes)*8)));
  }
  pRCQ->A = A;
  pRCQ->B = B;
  pRCQ->C = C;
  pRCQ->D = D;
  //Restore the 4 bytes we originally backed up.
  *((Int32*)&(pData[nBytes])) = R;
  //Return the sum of A,B,C,D as a checksum.
  return (A+B+C+D);
}
```

An example of an implementation of the method 50 (FIG. 4) and the method 90 (FIG. 6) in C code in accordance with another embodiment of the present invention is as follows:

```
typedef struct RCQ
{
    Int32 A;
    Int32 B;
    Int32 C;
    Int32 D;
} RCQ;
```

Initializing the Processing Unit:

```
void rcqInit(const Byte pKey[16], RCQ* pRCQ)
{
    memcpy(pRCQ, pKey, sizeof(*pRCQ));
    rcqEncrypt(pRCQ, (Int32*)pRCQ, sizeof(RCQ)/sizeof(Int32));
}
```

Encrypting Data:

```
Int32 rcqEncrypt(RCQ* pRCQ, Int32* pData, Int32 nWords)
{
  Int32 A = pRCQ->A;
  Int32 B = pRCQ->B;
  Int32 C = pRCQ->C;
  Int32 D = pRCQ->D;
  while (nWords-- > 0)
  {
    D \hat{ }= 0x5B3AA654;
    C += D + A;
    C = (C<<7)|(C>>25);
    B += C + D;
    C \hat{ }= 0x75970A4D;
    B = (B<<11)|(B>>21);
    A += B + C;
    A = (A<<17)|(A>>15);
    D += (A&B)|(C&(˜B));
    B = ˜B;
    A = ˜A;
    D \hat{ }= (*pData);
    *pData = D;
    pData++;
  }
  pRCQ->A = A;
  pRCQ->B = B;
  pRCQ->C = C;
  pRCQ->D = D;
  return (A+B+C+D);
}
```

Decrypting Data:

```
Int32 rcqDecrypt(RCQ* pRCQ, Int32* pData, Int32 nWords)
{
  Int32 A = pRCQ->A;
  Int32 B = pRCQ->B;
  Int32 C = pRCQ->C;
  Int32 D = pRCQ->D;
  while (nWords-- > 0)
  {
    D \hat{ }= 0x5B3AA654;
    C += D + A;
    C = (C<<7)|(C>>25);
    B += C + D;
    C \hat{ }= 0x75970A4D;
    B = (B<<11)|(B>>21);
    A += B + C;
    A = (A<<17)|(A>>15);
    D += (A&B)|(C&(˜B));
    B = ˜B;
    A = ˜A;
    *pData \hat{ }= D;
    D \hat{ }= (*pData);
    pData++;
  }
  pRCQ->A = A;
  pRCQ->B = B;
  pRCQ->C = C;
  pRCQ->D = D;
  return (A+B+C+D);
}
```

An example of an implementation of the method 50 (FIG. 4) and the method 90 (FIG. 6) in C code in accordance with another embodiment of the present invention is as follows:

| void rcqInit(const struct RC_KEY* pKey, RCQ* pRCQ) | |
|---|---|
| { | |
| memcpy(pRCQ, pKey, sizeof(*pRCQ)); | |
| rcqEncrypt(pRCQ, (RT_U4BYTE*)pRCQ, | |
| sizeof(*pRCQ)/sizeof(RT_U4BYTE)); | |
| } | |
| RT_U4BYTE rcqEncrypt | |
| ( | |
| RCQ* | pRCQ, |
| RT_U4BYTE* | pData, |
| RT_U4BYTE | nWords |
| ) | |
| { | |
| RT_U4BYTE A = pRCQ->A; | |
| RT_U4BYTE B = pRCQ->B; | |
| RT_U4BYTE C = pRCQ->C; | |
| RT_U4BYTE D = pRCQ->D; | |
| while (nWords-- > 0) | |
| { | |
| D \hat{ }= 0x5B3AA654; | |
| C += D + A; | |
| C = (C<<7)\|(C>>25); | |
| B += C + D; | |
| C \hat{ }= 0x75970A4D; | |
| B = (B<<11)\|(B>>21); | |
| A += B + C; | |
| A = (A<<17)\|(A>>15); | |
| D += (A&B)\|(C&(˜B)); | |
| B = ˜B; | |
| A = ˜A; | |
| D \hat{ }= (*pData); | |
| *pData = D; | |
| pData++; | |
| } | |
| pRCQ->A = A; | |
| pRCQ->B = B; | |
| pRCQ->C = C; | |
| pRCQ->D = D; | |
| return (A+B+C+D); | |
| } | |
| RT_U4BYTE rcqDecrypt | |
| ( | |
| RCQ* | pRCQ, |
| RT_U4BYTE* | pData, |
| RT_U4BYTE | nWords |
| ) | |

```
{
  RT_U4BYTE A = pRCQ->A;
  RT_U4BYTE B = pRCQ->B;
  RT_U4BYTE C = pRCQ->C;
  RT_U4BYTE D = pRCQ->D;
  while (nWords-- > 0)
  {
    D \hat{ }= 0x5B3AA654;
    C += D + A;
    C = (C<<7)|(C>>25);
    B += C + D;
    C \hat{ }= 0x75970A4D;
    B = (B<<11)|(B>>21);
    A += B + C;
    A = (A<<17)|(A>>15);
    D += (A&B)|(C&(˜B));
    B = ˜B;
    A = ˜A;
    *pData \hat{ }= D;
    D \hat{ }= *pData;
    pData++;
  }
  pRCQ->A = A;
  pRCQ->B = B;
  pRCQ->C = C;
  pRCQ->D = D;
  return (A+B+C+D);
}
```

An example of an implementation of the method 50 (FIG. 4) in C code in accordance with another embodiment of the present invention for performing a hash operation is as follows:

```
void rcqHashInit
(
  RCQ* pRCQ
)
{
  memset(pRCQ, 0, sizeof(*pRCQ));
  rcqEncrypt(pRCQ, (RT_U1BYTE*)pRCQ, sizeof(*pRCQ));
}
void rcqHashFinal
(
  const RCQ*  pRCQ,
  char  hashOut[16]
)
{
  Int32  theOutput[4];
  theOutput[3] = pRCQ->A \hat{ } pRCQ->B \hat{ } pRCQ->C \hat{ } pRCQ->D;
  theOutput[0] = theOutput[3] \hat{ } pRCQ->A;
  theOutput[1] = theOutput[3] \hat{ } pRCQ->B;
  theOutput[2] = theOutput[3] \hat{ } pRCQ->C;
  theOutput[3] = theOutput[3] \hat{ } pRCQ->D;
  memcpy(hashOut, theOutput, sizeof(theOutput));
}
Int32 rcqChecksum
(
  char*  pData,
  Int  nBytes
)
{
  RCQ  theRCQ;
  rcqHashInit(&theRCQ);
  rcqHashUpdate(&theRCQ, pData, nBytes);
  return (theRCQ.A + theRCQ.B + theRCQ.C + theRCQ.D);
}
```

An example of an implementation of the hashing function and checksum functions in C code in accordance with another embodiment of the present invention is as follows:

| //Explanation of the usage of these functions: | |
|---|---|
| //1.For data hashing which produces 16 bytes as final output: | |
| // 1a. Call | |
| // rcqHashInit | |
| // to initialize the processing unit. As in fig. 7, step 20. | |
| // It does the initialization by encrypting the processing | |
| // unit itself. | |
| // In the sample code below, in rcqHashInit, this “fixed and | |
| // known 16 bytes key is simply an all-bytes-zero 16 bytes key. | |
| // 1b. Call | |
| // rcqHashUpdate | |
| // to process the data to be hashed. The process is as in | |
| // step 36,38, 40. And is virtually identical to the | |
| encryption | |
| // process as detailed in fig.3 and fig.4, except there is no | |
| // step 78 (no data is put back to the buffer). | |
| // 1c. Call | |
| // rcqHashFinal | |
| // This step extracts the final 16 bytes hash output, | |
| // as in fig. 7, step 130. It outputs the check sum in four 4- | |
| bytes | |
| // integer, calculated respectively using B\hat{ }C\hat{ }D, C\hat{ }D\hat{ }A, D\hat{ }A\hat{ }B, | |
| A\hat{ }B\hat{ }C. | |
| //2. For calculating data checksum, a 4 bytes output. Call function | |
| // rcqChecksum | |
| // Note the Checksum calculation process is exactly the same | |
| // as hashing, except it gets the 4 bytes output at the end | |
| // in slightly different way: It simply output the sum of ABCD. | |
| ///////////////////////////////////////////////////////////////////// | |
| ///////// | |
| // Forward declaration | |
| struct RC_KEY; | |
| typedef struct RCQ | |
| { | |
| Int32 A; | |
| Int32 B; | |
| Int32 C; | |
| Int32 D; | |
| } RCQ; | |
| // Below is the Hash functions: rcqHashInit, rcqHashUpdate, | |
| rcqHashFinal | |
| void rcqHashInit | |
| ( | |
| RCQ* pRCQ | |
| ) | |
| { | |
| memset(pRCQ, 0, sizeof(*pRCQ)); | |
| rcqEncrypt(pRCQ, (Byte*)pRCQ, sizeof(*pRCQ)); | |
| } | |
| void rcqHashUpdate | |
| ( | |
| RCQ* pRCQ, | |
| Byte* pData, | |
| Int32 nBytes | |
| ) | |
| { | |
| Int32 A = pRCQ->A; | |
| Int32 B = pRCQ->B; | |
| Int32 C = pRCQ->C; | |
| Int32 D = pRCQ->D; | |
| //Back up 4 bytes beyond our data. This will be restored later | |
| Int32 R = *((Int32*)&(pData[nBytes])); | |
| //Make those 4 bytes zero. Part of it padding bytes and encrypted | |
| *((Int32*)&(pData[nBytes])) = 0; | |
| //Loop until all input data are encrypted. | |
| while (nBytes > 0) | |
| { | |
| nBytes −= sizeof(Int32); | |
| D \hat{ }= 0x5B3AA654; | |
| C += D + A; | |
| C = (C<<7)\|(C>>25); | |
| B += C + D; | |
| C \hat{ }= 0x75970A4D; | |
| B = (B<<11)\|(B>>21); | |
| A += B + C; | |
| A = (A<<17)\|(A>>15); | |
| D += (A&B)\|(C&(˜B)); | |
| B = ˜B; | |
| A = ˜A; | |
| D \hat{ }= *((Int32*)pData); | |
| //This step not taken. This is the only difference from the | |
| encrypting | |
| //function. We do not put the encrypted data back to the | |
| buffer. | |
| //*((Int32*)pData) = D; | |
| pData += sizeof(Int32); | |
| } | |
| pRCQ->A = A; | |
| pRCQ->B = B; | |
| pRCQ->C = C; | |
| pRCQ->D = D; | |
| //Restore the original 4 bytes backed up. | |
| *((Int32*)&(pData[nBytes])) = R; | |
| } | |
| void rcqHashFinal | |
| ( | |
| const RCQ* | pRCQ, |
| Byte | hashOut[16] |

```
)
{
  Int32  theOutput[4];
  theOutput[3] = pRCQ->A \hat{ } pRCQ->B \hat{ } pRCQ->C \hat{ } pRCQ->D;
  theOutput[0] = theOutput[3] \hat{ } pRCQ->A;
  theOutput[1] = theOutput[3] \hat{ } pRCQ->B;
  theOutput[2] = theOutput[3] \hat{ } pRCQ->C;
  theOutput[3] = theOutput[3] \hat{ } pRCQ->D;
  memcpy(hashOut, theOutput, sizeof(theOutput));
}
///////////////// Below is the Checksum function ////////
// Note the Checksum process is exactly identical to hash,
// except it use different way to get the final output.
// That's why whithin this function it calls the same
// rcqHashInit( ) and rcqHashUpdate( ), but do slightly
// different thing than rcqHashFinal( ).
Int32 rcqChecksum
(
  Byte* pData,
  Int32 nBytes
)
{
  RCQ  theRCQ;
  rcqHashInit(&theRCQ);
  rcqHashUpdate(&theRCQ, pData, nBytes);
  return (theRCQ.A + theRCQ.B + theRCQ.C + theRCQ.D);
}
```

While described by means of specific embodiments and applications thereof, numerous modifications and variations could be made thereto by those skilled in the art without departing from the scope of the invention set forth in the claims.

What is claimed is:

1. A method for use in processing data, comprising the steps of:
loading a key into a plurality of registers;
performing a series of operations on the registers to manipulate bits in the registers; and
performing an exclusive OR (XOR) operation on contents of one of the registers and a portion of the data.

2. A method in accordance with claim 1, wherein the plurality of registers comprises four registers.

3. A method in accordance with claim 2, wherein the four registers are each thirty-two bits in length.

4. A method in accordance with claim 1, wherein the data comprises original data and wherein the step of performing an XOR operation comprises the step of:
a register D is XOR'ed with a portion of the original data.

5. A method in accordance with claim 1, wherein the data comprises encrypted data to be decrypted and wherein the step of performing an XOR operation comprises the step of:
a portion of the encrypted data is XOR'ed with contents of a register D.

6. A method in accordance with claim 1, wherein the step of performing a series of operations on the registers comprises the step of:
a register D is increased by an integer X so constructed that each of X's bits come from either a corresponding bit of a register A if a corresponding bit in a register B is 1, or a corresponding bit of a register C if the corresponding bit in register B is 0.

7. A method in accordance with claim 1, wherein the step of performing a series of operations on the registers comprises the steps of:
a register D is changed by an XOR operation with an integer K4;
a register C is increased by a sum of the register D and a register A;
the register C is circular rotated left N3 bits;
a register B is increased by a sum of registers C and D;
the register C is changed by an XOR operation with an integer K3;
the register B is circular rotated left N2 bits;
the register A is increased by a sum of registers B and C; and
the register A is circular rotated left N1 bits.

8. A method in accordance with claim 7, wherein the step of performing a series of operations on the registers further comprises the steps of:
the register D is increased by an integer X so constructed that each of X's bits come from either a corresponding bit of the register A if a corresponding bit in the register B is 1, or a corresponding bit of the register C if the corresponding bit in the register B is 0;
a bit invert operation is performed on the register B; and
a bit invert operation is performed on the register A.

9. A system for use in processing data, comprising:
a plurality of registers; and
a processing unit configured to,
load a key into the plurality of registers;
perform a series of operations on the registers to manipulate bits in the registers; and
perform an exclusive OR (XOR) operation on contents of one of the registers and a portion of the data.

10. A system in accordance with claim 9, wherein the plurality of registers comprises four registers.

11. A system in accordance with claim 10, wherein the four registers are each thirty-two bits in length.

12. A system in accordance with claim 9, wherein the data comprises original data and wherein the processing unit is further configured to perform the XOR operation according to the step of:
a register D is XOR'ed with a portion of the original data.

13. A system in accordance with claim 9, wherein the data comprises encrypted data to be decrypted and wherein the processing unit is further configured to perform the XOR operation according to the step of:
a portion of the encrypted data is XOR'ed with contents of a register D.

14. A system in accordance with claim 9, wherein the processing unit is further configured to perform the series of operations on the registers according to the step of:
a register D is increased by an integer X so constructed that each of X's bits come from either a corresponding bit of a register A if a corresponding bit in a register B is 1, or a corresponding bit of a register C if the corresponding bit in register B is 0.

15. A system in accordance with claim 9, wherein the processing unit is further configured to perform the series of operations on the registers according to the steps of:
a register D is changed by an XOR operation with an integer K4;
a register C is increased by a sum of the register D and a register A;
the register C is circular rotated left N3 bits;
a register B is increased by a sum of registers C and D;
the register C is changed by an XOR operation with an integer K3;
the register B is circular rotated left N2 bits;
the register A is increased by a sum of registers B and C; and
the register A is circular rotated left N1 bits.

16. A system in accordance with claim 15, wherein the processing unit is further configured to perform the series of operations on the registers according to the steps of:
the register D is increased by an integer X so constructed that each of X's bits come from either a corresponding bit of the register A if a corresponding bit in the register B is 1, or a corresponding bit of the register C if the corresponding bit in the register B is 0;
a bit invert operation is performed on the register B; and
a bit invert operation is performed on the register A.

17. A computer program product comprising a medium for embodying a computer program for input to a computer and a computer program embodied in the medium for causing the computer to perform steps of:
loading a key into a plurality of registers;
performing a series of operations on the registers to manipulate bits in the registers; and
performing an exclusive OR (XOR) operation on contents of one of the registers and a portion of data.

18. A computer program product in accordance with claim 17, wherein the step of performing a series of operations on the registers comprises the step of:
a register D is increased by an integer X so constructed that each of X's bits come from either a corresponding bit of a register A if a corresponding bit in a register B is 1, or a corresponding bit of a register C if the corresponding bit in register B is 0.

19. A computer program product in accordance with claim 17, wherein the step of performing a series of operations on the registers comprises the steps of:
a register D is changed by an XOR operation with an integer K4;
a register C is increased by a sum of the register D and a register A;
the register C is circular rotated left N3 bits;
a register B is increased by a sum of registers C and D;
the register C is changed by an XOR operation with an integer K3;
the register B is circular rotated left N2 bits;
the register A is increased by a sum of registers B and C; and
the register A is circular rotated left N1 bits.

20. A computer program product in accordance with claim 19, wherein the step of performing a series of operations on the registers further comprises the steps of:
the register D is increased by an integer X so constructed that each of X's bits come from either a corresponding bit of the register A if a corresponding bit in the register B is 1, or a corresponding bit of the register C if the corresponding bit in the register B is 0;
a bit invert operation is performed on the register B; and
a bit invert operation is performed on the register A.
